(19) United States
(12) Patent Application Publication
(10) Pub. No.: US 2026/0077984 A1
(43) Pub. Date: Mar. 19, 2026

(54) DRIVE SYSTEM FOR A WORK VEHICLE

(71) Applicant: Palfinger AG, Bergheim bei Salzburg (AT)

(72) Inventors: Christian ROSENHAMMER, Bergheim bei Salzburg (AT); Mario HASLAUER, Bergheim bei Salzburg (AT)

(21) Appl. No.: 19/327,619

(22) Filed: Sep. 12, 2025

(30) Foreign Application Priority Data
Sep. 13, 2024 (AT) GM501192024

(51) Int. Cl. B66F 9/075; B66F 9/22

(52) U.S. Cl. CPC B66F 9/07572; B66F 9/22; B66F 9/07563

(57) ABSTRACT

A drive system for a work vehicle, for example a truck-mounted forklift, with at least one driven wheel, and the drive system includes a hydraulic pump designed to drive the driven wheel, and an electric motor mechanically coupled to the hydraulic pump. The electric motor is designed to drive the hydraulic pump, and the hydraulic pump is a variable displacement pump.

### BACKGROUND OF THE INVENTION

The present invention relates to a drive system for a work vehicle, for example a truck-mounted forklift, with at least one driven wheel. The drive system includes:
a hydraulic pump which is designed to drive the at least one driven wheel, and
an electric motor mechanically coupled to the hydraulic pump, with said electric motor being designed to drive the hydraulic pump.

Furthermore, the invention relates to a work vehicle with such a drive system and a method for operating such a drive system or work vehicle.

Drive systems of this type are primarily used in compact electric work vehicles such as forklifts, excavators, or the like, wherein they are intended in particular for the traction drive or, respectively, driving the wheels, such as wheels with tires or the drive wheels of a track drive. Such electric work vehicles should be as compact as possible and capable of energy-efficient operation. EP 3 722 516 A1 offers an approach in which, on the one hand, two separate drive trains are provided for the travel hydraulics and the working hydraulics and, wherein, on the other hand, the drive train of the travel hydraulics is designed to transmit the rotation of a constant pump directly proportionally to the wheels.

A disadvantage of a hydraulic drive train designed this way is that this drive train cannot serve any other consumers, as this would prevent direct transmission from the pump to the wheels. Since the constant pump is also driven by an electric motor mechanically coupled to it, it is absolutely necessary to operate the electric motor at revolutions per minute corresponding to the desired movement of the wheels. Under certain circumstances, this might make it necessary for the electric motor to be operated in an unfavorable operating state. Further, it is possible that the movement of the wheels is excessively limited by a maximum of motor revolutions per minute.

### SUMMARY OF THE INVENTION

The task of the present invention is therefore to provide an improved drive system compared to the prior art which can be used and operated more flexibly and therefore, for example, allows gentler operation of the electric motor.

This task is solved a drive system of the type mentioned at the beginning, in which the hydraulic pump is a variable displacement pump.

The use of a variable displacement pump makes it possible to open-loop or closed-loop control the at least one driven wheel by means of both the hydraulic pump and the electric motor. In other words, the movement of the at least one driven wheel does not depend exclusively on the revolutions per minute and/or a rotational direction of the electric motor.

The drive system according to the invention is therefore significantly more flexible than that according to the prior art. For example, the drive system can supply additional consumers or operate the electric motor in an operating state that is favorable for it, i.e., in particular, one that is gentle on materials and energy-saving.

The variable displacement pump is preferably an axial piston pump with a variable displacement unit, preferably a swivel plate.

The at least one driven wheel of the work vehicle to be driven is preferably a wheel with tires. The at least one driven wheel can also be a drive wheel of a track drive. It can also be a drive unit of a track drive.

In particularly preferred embodiments, the drive system has an open-loop or closed-loop control unit which is designed to open-loop or closed-loop control the electric motor and the hydraulic pump, in particular a variable displacement unit such as a swivel plate of the hydraulic pump. This allows the movement of the at least one driven wheel, in particular its rotational direction and/or its rotational speed, to be open-loop or closed-loop controlled with particular precision.

The open-loop or closed-loop control of the electric motor and the hydraulic pump does not necessarily have to take place simultaneously. The open-loop or closed-loop control unit is preferably designed to effect a desired movement of the at least one driven wheel primarily by open-loop or closed-loop controlling the hydraulic pump, in particular the variable displacement unit, and secondarily by open-loop or closed-loop controlling the electric motor.

Preferably, the open-loop or closed-loop control unit is designed to open-loop or closed-loop control the electric motor depending on the status of the hydraulic pump and the hydraulic pump depending on the status of the electric motor.

In a particularly preferred embodiment, the drive system is designed to maintain a rotational direction of the electric motor and to open-loop or closed-loop control the direction of flow that can be generated by the hydraulic pump by means of the hydraulic pump itself, in particular by the variable displacement unit.

The flow direction within the drive system, preferably of the first drive train, is therefore preferably determined by open-loop or closed-loop controlling the flow direction of the hydraulic pump.

It is possible that the open-loop or closed-loop control unit is designed to maintain the revolutions per minute of the electric motor within a defined range and to open-loop or closed-loop control the hydraulic pump, in particular the variable displacement unit, in such a way as to generate the desired movement of the at least one driven wheel. This allows the electric motor to be operated in a particular efficient way within a range of revolutions per minute that saves energy and/or protects the material.

Preferably, the open-loop or closed-loop control unit is designed to open-loop or closed-loop control a volume flow that can be generated by the hydraulic pump based on the revolutions per minute of the hydraulic pump and/or a displacement volume per revolution of the hydraulic pump.

In particularly preferred embodiments, the drive system has at least one hydraulic motor fluidly connected to the hydraulic pump, with said hydraulic motor being designed to be driven by the hydraulic pump and to drive the at least one driven wheel.

At least the electric motor and the hydraulic pump can form a first hydraulic drive train for driving the at least one driven wheel.

In preferred embodiments, in addition to the at least one driven wheel, at least two, for example three or four, wheels are provided, preferably wherein a hydraulic motor is arranged upstream of each wheel.

In particularly preferred embodiments, the first drive train is a closed hydraulic circuit. This makes it particularly easy, for example, to generate higher rotational speeds of the at least one driven wheel. This way, for example, the rotational direction of the at least one driven wheel can be changed by reversing the flow direction of the hydraulic fluid without any performance degradation in the hydraulic circuit.

It is particularly preferred that the drive system has a feed pump, preferably mechanically coupled to the hydraulic pump, with said feed pump designed to provide and maintain a predetermined operating pressure in the drive system, preferably in the first drive train.

In preferred embodiments, the drive system, preferably the first drive train, has a brake unit, preferably comprising at least one brake hydraulic cylinder. The brake unit is designed to brake and/or block at least one wheel, and is preferably designed to brake and/or block a hydraulic motor arranged upstream of the at least one driven wheel.

The brake unit can be designed to brake and/or block several or all wheels or the hydraulic motors arranged upstream of them.

The drive system preferably has at least one second hydraulic drive train with a second electric motor and a second hydraulic pump mechanically coupled to the second electric motor. The second hydraulic pump is designed to drive at least one consumer of the work vehicle.

The second drive train is preferably to be understood as a work hydraulic train.

The at least one consumer is in particular a hydraulic consumer, in particular a hydraulic cylinder.

If the work vehicle is a truck-mounted forklift or the like, then the at least one consumer is preferably five consumers, which are provided for operating a fork carrier and a support device of the forklift, in particular wherein one consumer each is responsible for the functions of lifting and lowering, increasing and reducing the reach, tilting the fork carrier up and down, moving it to the left and right, and moving a support device down and up.

In preferred embodiments, the second hydraulic pump for driving the at least one consumer is a one-way pump.

It is particularly preferred that the open-loop or closed-loop control unit is designed to
open-loop or closed-loop control a volume flow that can be generated by the at least one second hydraulic pump, preferably on request from the at least one consumer.

The electric motor and/or the second electric motor is or are designed to be open-loop or closed-loop controlled by at least one signal generated by the request of the at least one consumer.

The at least one signal can be a mechanical, electrical, or hydraulic signal.

The at least one signal can be converted and/or obtained by signal conversion.

The open-loop or closed-loop control unit is designed to open-loop or closed-loop control the hydraulic pump and/or the electric motor and/or the second hydraulic pump and/or the second electric motor in such way as to generate a variable and/or constant volume flow.

It is possible that exclusively a variable volume flow or exclusively a constant volume flow is generated.

It is also possible that the volume flow is a superposition of a variable and a constant volume flow and/or that a variable and a constant volume flow are generated alternately.

In particularly preferred embodiments, the second hydraulic pump is a constant pump with a constant displacement volume per revolution of the hydraulic pump, preferably wherein the open-loop or closed-loop control unit is designed to open-loop or closed-loop control the volume flow based on the revolutions per minute of the second hydraulic pump.

It is particularly preferred that the open-loop or closed-loop control unit is designed to
open-loop or closed-loop control the second electric motor, preferably the revolutions per minute of the second electric motor and/or on the basis of at least one request from one or more consumers.

Alternatively, the second hydraulic pump can be a variable displacement pump, preferably wherein the open-loop or closed-loop control unit is designed to open-loop or closed-loop control the volume flow on the basis of a variable parameter such as a swivel angle and/or the revolutions per minute of the second hydraulic pump.

In preferred embodiments, the open-loop or closed-loop control unit is designed to open-loop or closed-loop control the electric motor and/or the hydraulic pump and/or the second electric motor and/or the second hydraulic pump by means of at least one function request from an operator, preferably in real time.

The at least one requested function is, in particular, the movement of the at least one driven wheel, e.g., at a desired speed and/or at desired revolutions per minute and in a first direction or in a second direction.

The at least one function request can be made, for example, by an operator actuating a pedal, lever, and/or button, etc., wherein the actuation can take place in or on the work vehicle and/or also be remote-controlled.

It is also conceivable that the function request can be made by an autonomous system, etc.

The drive system can comprise at least one pressure control valve, in particular wherein the at least one pressure control valve is arranged upstream of the at least one driven wheel, preferably the at least one hydraulic motor, and/or the at least one consumer.

In the second drive train, at least one multi-way valve, which, for example, can be actuated by means of a lever, is provided, in particular by means of which the at least one consumer can be activated.

The at least one second drive train is preferably an open hydraulic circuit.

It is particularly preferred that a primary consumer with a defined power requirement is arranged upstream of the at least one consumer in the second drive train. Preferably, the drive system is designed to provide the primary consumer with a quantity of hydraulic fluid to cover its defined power requirement by means of a device for closed-loop controlling the prioritized energy supply.

The primary consumer is preferably a hydraulic cylinder of a steering system of the work vehicle. In particular, this means that the work vehicle can be steered reliably and safely at all times.

It is particularly preferred that the first drive train and the at least one second drive train are designed separately from each other, i.e., in particular hydraulically unconnected. However, it is also conceivable that the first drive train and the at least one second drive train are hydraulically connected to each other, for example for pressure equalization purposes.

Furthermore, protection is sought for a work vehicle, in particular a truck-mounted forklift, with a drive system according to the invention and at least one wheel that can be driven by the drive system.

The at least one driven wheel of the work vehicle to be driven is preferably a wheel with tires. The at least one driven wheel can also be a drive wheel of a track drive.

Particularly preferably, the work vehicle is a forklift with three or four wheels and with several, preferably five, consumers for operating a fork carrier and a support device of the forklift, in particular wherein one consumer each is provided for the functions lifting and lowering, increasing and reducing the reach, tilting the fork carrier up and down, moving it to the left and right, and moving the support device up and down.

In particularly preferred embodiments, the drive system, preferably of the work vehicle, comprises at least one battery for supplying power to the electric motor and preferably to the second electric motor.

Protection is also sought for a method for operating a drive system and/or work vehicle according to the invention, wherein the electric motor and the hydraulic pump, in particular a swivel plate of the hydraulic pump, are open-loop or closed-loop controlled to drive the at least one driven wheel.

### BRIEF DESCRIPTION OF THE DRAWINGS

Further advantages of the invention will be apparent from the drawings and the accompanying description of the drawings, in which:

FIGS. 1-3 each show a section of a preferred embodiment of a drive system according to the invention.

### DETAILED DESCRIPTION OF THE INVENTION

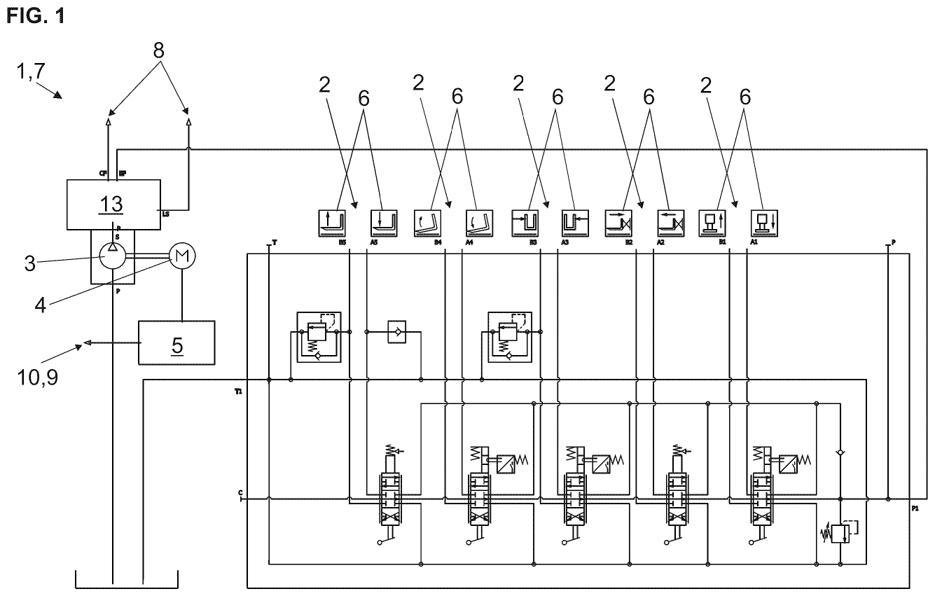

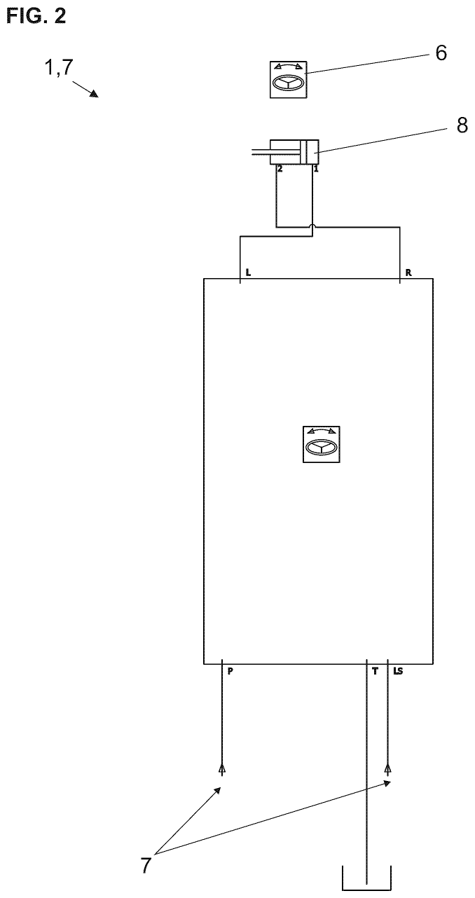

The sections shown in FIGS. 1-3 together form the preferred embodiment of a drive system 1 according to the invention. FIG. 1 shows a section of the drive system 1 with an optional second drive train 7, and FIG. 2 shows a primary consumer 8 provided in the second drive train 7.

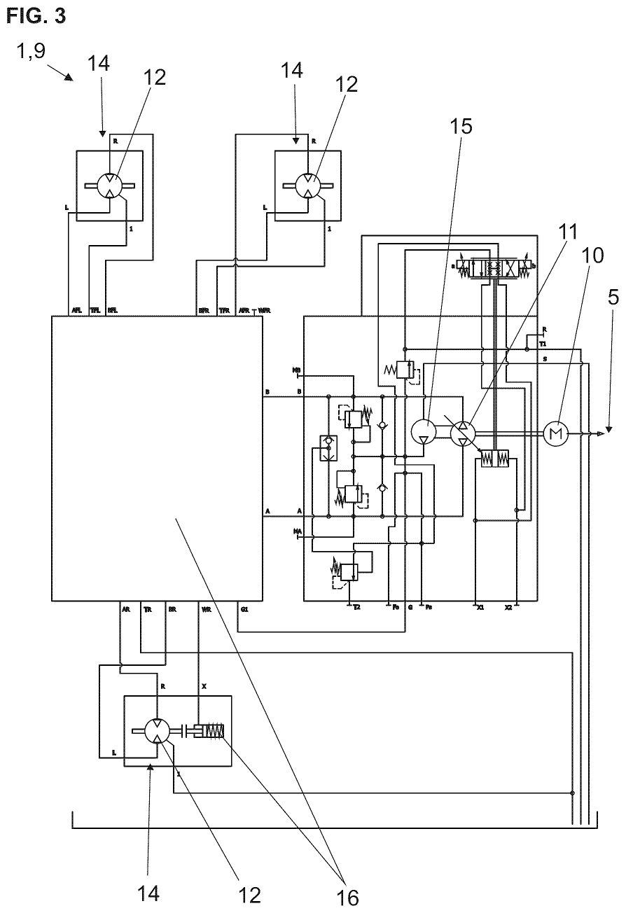

FIG. 3 essentially shows the main section of the drive system 1 with a first drive train 9.

FIG. 1 therefore shows a section of a preferred embodiment of a drive system 1 for a work vehicle, for example a truck-mounted forklift, with at least one consumer 2, wherein the drive system 1 comprises:
a second hydraulic pump 3, which is designed to drive the at least one consumer 2,
a second electric motor 4 mechanically coupled to the second hydraulic pump 3 with said second electric motor 4 being designed to drive the second hydraulic pump 3, and
an open-loop or closed-loop control unit 5.

In this embodiment, the open-loop or closed-loop control unit 5 is designed to open-loop or closed-loop control the second electric motor 4.

In this case, at least the second electric motor 4 and the second hydraulic pump 3 form a second hydraulic drive train 7 which is designed to drive at least one consumer 2, in this case specifically five consumers 2.

The consumers 2, preferably hydraulic cylinders, are not shown; they would be connected to the hydraulic lines extending upward. However, a total of five exemplary functions 6 that can be implemented by the consumers 2 are shown. These five functions 6 are, from left to right: lifting and lowering a fork carrier of a work vehicle, tilting the fork carrier up and down, moving the fork carrier to the left and right, increasing and reducing the reach of the fork carrier, and moving a support device up and down.

In this embodiment, the open-loop or closed-loop control unit 5 is designed to open-loop or closed-loop control the volume flow at the request of at least one consumer 2, i.e., in particular at the request of one or more consumers 2 of the five existing consumers 2.

Preferably, the request from the respective consumer 2 corresponds to a defined maximum power requirement of this consumer 2.

Since there are several consumers 2 here, the open-loop or closed-loop control device 5 is preferably designed to open-loop or closed-loop control the volume flow on the basis of a sum of the individual requests of the at least two consumers 2.

In this embodiment, the open-loop or closed-loop control unit 5 is designed to generate a proportional and/or constant volume flow depending on the respective function 6 of the respective consumer 2.

The second hydraulic pump 3 is preferably a constant pump with a constant displacement volume per revolution of the second hydraulic pump 3, wherein the open-loop or closed-loop control unit 5 is designed to open-loop or closed-loop control the volume flow on the basis of the revolutions per minute of the second hydraulic pump 3.

In this embodiment, the open-loop or closed-loop control unit 5 is designed to open-loop or closed-loop control the volume flow through at least one function request to the at least one consumer 2 by an operator. For example, an operator can actuate a lever on a work vehicle to perform one or more functions 6, e.g., lifting and/or tilting a fork carrier, whereupon the associated consumer 2 or consumers request(s) a volume flow required for the function(s) 6.

In particular, the open-loop or closed-loop control and the subsequent processes take place in real time, i.e., in particular immediately as a result of the at least one function request.

In FIG. 1, as a preferred variant, a valve 13 is arranged adjacent to the second
hydraulic pump 3, from which valve a primary consumer 8 (shown in FIG. 2) is provided, preferably wherein the primary consumer 8 is arranged upstream of the at least one consumer 2 in the second drive train 7.

The valve 13 is preferably a changeover valve, in particular a load-sensing valve functioning as a priority valve, which is in particular designed to ensure that the defined power requirement of the primary consumer 8 is always met.

In FIG. 1, as a preferred variant, starting from the open-loop or closed-loop control unit 5, a control line to the electric motor 10, preferably of a first drive train 9, is shown (see FIG. 3).

FIG. 2 shows a second section of the preferred embodiment of a drive system 1, wherein, in this case, the primary consumer 8 mentioned in FIG. 1 is shown, which is arranged upstream of the at least one consumer 2 in the second drive train 7.

In this embodiment, the drive system 1 is designed, in particular by means of the valve 13, to supply the primary consumer 8 with a quantity of hydraulic fluid to cover the defined power requirement of the primary consumer 8.

The primary consumer 8 is in particular a hydraulic cylinder for steering, preferably wherein a gear rack may be provided on the hydraulic cylinder for performing a rotary movement. This means in particular that the function 6 of this primary consumer 8 is to steer the work vehicle.

FIG. 3 shows a third section or the main section of the preferred embodiment of a
drive system 1 for a work vehicle, for example a truck-mounted forklift, with at least one wheel 14, wherein the drive system 1 comprises:
   a hydraulic pump 11, which is designed to drive the at least one wheel 14, and
   an electric motor 10 mechanically coupled to the hydraulic pump 11, with the electric motor 10 being designed to drive the hydraulic pump 11,
wherein the hydraulic pump 11 is a variable displacement pump.

In this preferred embodiment, the drive system 1 has at least one hydraulic motor 12 which is fluidly connected to the hydraulic pump 11 and is arranged upstream of the at least one
wheel 14. FIG. 3 only shows the at least one hydraulic motor 12; not the at least one wheel 14 itself. The at least one wheel 14 is indicated only by arrows.

Starting from the electric motor 10, a control line is shown which is connected to the
open-loop or closed-loop control unit 5 (see FIG. 1).

The open-loop or closed-loop control unit 5 in particular is designed to open-loop or
closed-loop control the second drive train 7 and the first drive train 9.

In this embodiment, the open-loop or closed-loop control unit 5 is designed to open-loop or closed-loop control the electric motor 10 and the hydraulic pump 11, in particular a variable displacement unit such as a swivel plate of the hydraulic pump 11.

In this case, the open-loop or closed-loop control unit 5 is further designed to maintain the revolutions per minute of the electric motor 10 within a defined range and to open-loop or closed-loop control the hydraulic pump 11, in particular the variable displacement unit, in such way as to achieve a desired movement of the at least one wheel 14.

In this preferred embodiment, the first drive train 9 is a closed hydraulic circuit, preferably comprising a feed pump 15, which is designed to provide and maintain a predetermined operating pressure in the drive system 1, preferably in the first drive train 9.

In this embodiment, the feed pump 15 is mechanically coupled to the hydraulic pump 11.

FIG. 3 also shows a preferably provided brake unit 16 with at least one brake hydraulic cylinder, wherein the brake unit 16 is designed to brake and/or block at least one wheel 14.

### LIST OF REFERENCES

1 drive system
2 consumer
3 second hydraulic pump
4 second electric motor
5 open-loop or closed-loop control unit
6 function
7 second drive train
8 primary consumer
9 first drive train
10 electric motor
11 hydraulic pump
12 hydraulic motor
13 priority valve
14 wheel
15 feed pump
16 brake unit

1. A drive system for a work vehicle, for example a truck-mounted forklift, with at least one driven wheel, wherein the drive system comprises:
a hydraulic pump which is designed to drive the at least one driven wheel, and
an electric motor mechanically coupled to the hydraulic pump,
wherein the electric motor is configured to drive the hydraulic pump, and the hydraulic pump is a variable displacement pump.

2. The drive system according to claim 1, wherein the drive system has an open-loop or closed-loop control unit which is designed to open-loop or closed-loop control the electric motor and the hydraulic pump, in particular a variable displacement unit of the hydraulic pump.

3. The drive system according to claim 2, wherein the open-loop or closed-loop control unit is designed to open-loop or closed-loop control a volume flow of the hydraulic fluid that can be generated by the hydraulic pump based on the revolutions per minute of the hydraulic pump and/or a displacement volume per revolution of the hydraulic pump.

4. The drive system according to claim 2, wherein the open-loop or closed-loop control unit is designed to maintain the revolutions per minute of the electric motor within a defined range and to open-loop or closed-loop control the hydraulic pump, in particular the variable displacement unit, in order to achieve a desired movement of the at least one driven wheel.

5. The drive system according to claim 1, wherein the drive system has at least one hydraulic motor fluidly connected to the hydraulic pump, with said hydraulic motor being designed to be driven by the hydraulic pump and to drive the at least one driven wheel.

6. The drive system according to claim 1, wherein at least the electric motor and the hydraulic pump form a first hydraulic drive train for driving the at least one driven wheel, preferably wherein at least two, for example three or four, wheels are additionally present.

7. The drive system according to claim 6, wherein the first drive train is a closed hydraulic circuit.

8. The drive system according to claim 1, wherein the drive system has a feed pump, preferably mechanically coupled to the hydraulic pump, with said feed pump being designed to provide and maintain a predetermined operating pressure in the drive system, preferably in the first drive train.

9. The drive system according to claim 1, wherein the drive system, preferably the first drive train, comprises a brake unit which is designed to brake and/or block at least one driven wheel.

10. The drive system according to claim 1, wherein the drive system has at least one second hydraulic drive train with a second electric motor and a second hydraulic pump mechanically coupled to the second electric motor, wherein the second hydraulic pump is designed to drive at least one consumer of the work vehicle.

11. The drive system according to claim 10, wherein a primary consumer with a defined power requirement is arranged upstream of the at least one consumer in the second drive train, preferably wherein the drive system is designed to supply the primary consumer with a quantity of hydraulic fluid to cover the defined power requirement by means of a device for closed-loop controlling the prioritized energy supply.

12. A work vehicle, in particular a truck-mounted forklift, with the drive system according to claim 1 and with at least one wheel that can be driven by the drive system.

13. A method of operating the work vehicle according to claim 12, wherein the electric motor and the hydraulic pump, in particular the swivel plate of the hydraulic pump, are open-loop or closed-loop controlled to drive the at least one driven wheel.
